(19) United States
(12) Patent Application Publication
(10) Pub. No.: US 2025/0142500 A1
(43) Pub. Date: May 1, 2025

(54) MULTI-CARRIER-BASED COMMUNICATION METHOD AND APPARATUS, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Shukun WANG, Dongguan (CN); Zhongda DU, Dongguan (CN); Cong SHI, Dongguan (CN)

(21) Appl. No.: 19/004,695

(22) Filed: Dec. 30, 2024

Related U.S. Application Data
(63) Continuation of application No. PCT/CN2022/105533, filed on Jul. 13, 2022.

(51) Int. Cl. H04W 56/00; H04L 5/14; H04W 68/02; H04W 72/02

(52) U.S. Cl. CPC H04W 56/0015; H04L 5/14; H04W 68/02; H04W 72/02

(57) ABSTRACT

Provided is a method for multi-carrier based communication, including that a terminal device perform an operation in a first cell based on a feature of the first cell. The first cell has at least one of the following features: the first cell including a plurality of downlink carriers; the first cell including a plurality of uplink carriers; the first cell including at least one downlink carrier that supports frequency division duplexing (FDD) and time division duplexing (TDD).

### CROSS-REFERENCE TO RELATED APPLICATION

This application is a continuation of International Patent Application No. PCT/CN2022/105533 filed on Jul. 13, 2022, the disclosure of which is incorporated herein by reference in its entirety.

### RELATED ART

Future communication systems (such as a 6G system) has a wider spectrum range, and terminal devices may operate in high or even ultra-high frequency spectrum ranges, which will lead to a higher time cost and larger energy consumption for the terminal devices to perform cell search. In addition, application scenarios of the future communication systems (such as the 6G system) will present more diversified characteristics, which significantly increases the number of connections in a cell, and thus an issue of initial access capacity is also a factor that needs to be taken into account.

### SUMMARY

Embodiments of the application relate to the technical field of mobile communications, and in particular to a method and an apparatus for multi-carrier based communication, a terminal device and a network device.

In embodiments of the present disclosure, there is provided a method and an apparatus for multi-carrier based communication, a terminal device, a network device, a chip, a computer readable storage medium, a computer program product and a computer program.

The method for multi-carrier based communication provided by the embodiments of the present disclosure includes the following actions.

A terminal device performs an operation in a first cell based on a feature of the first cell, where the first cell has at least one of the following features.

The first cell includes a plurality of downlink carriers.

The first cell includes a plurality of uplink carriers.

The first cell includes at least one downlink carrier supporting frequency division duplexing (FDD) and time division duplexing (TDD).

A terminal device provided by the embodiments of the present disclosure includes a processor and a memory. The memory is configured to store a computer program, and the processor is configured to call and execute the computer program stored in the memory to cause the terminal device to implement the above method for multi-carrier based communication.

A network device provided by the embodiments of the present disclosure includes a processor and a memory. The memory is configured to store a computer program, and the processor is configured to call and execute the computer program stored in the memory to cause the network device to implement the above method for multi-carrier based communication.

According to the above technical solution, a redefined cell has at least one of the following features: the cell including a plurality of downlink carriers; the cell including a plurality of uplink carriers; or the cell including at least one downlink carrier supporting FDD and TDD. Such cells can adapt to the complex business requirements and application scenarios of the future communication systems (such as the 6G system), and meet requirements of low latency in cell search, low energy consumption during cell search, and large initial access capacity of the cell.

### BRIEF DESCRIPTION OF THE DRAWINGS

The accompanying drawings illustrated herein are used to provide further understanding of the present disclosure and constitute a part of the present disclosure, and illustrative embodiments of the present disclosure and their description are used to explain the present disclosure, but do not constitute improper limitation to the present disclosure, wherein:

FIG. 1 is a schematic diagram of an architecture of a communication system provided by an embodiment of the present disclosure.

FIG. 2 is a schematic flowchart of a method for multi-carrier-based communication provided by an embodiment of the present disclosure.

FIG. 3A is a schematic diagram illustrating that a plurality of downlink carriers belong to the same frequency band provided by an embodiment of the present disclosure.

FIG. 3B is a schematic diagram illustrating that a plurality of downlink carriers belong to different frequency bands provided by an embodiment of the present disclosure.

FIG. 4 is a schematic diagram of a plurality of uplink carriers provided by an embodiment of the present disclosure.

FIG. 5 is a schematic diagram of carriers supporting TDD and FDD provided by an embodiment of the present disclosure.

FIG. 6 is a schematic diagram of cross-cell handover provided by an embodiment of the present disclosure.

FIG. 7 is a first structural composition diagram of an apparatus for multi-carrier-based communication provided by an embodiment of the present disclosure.

FIG. 8 is a second structural composition diagram of an apparatus for multi-carrier-based communication provided by an embodiment of the present disclosure.

FIG. 9 is a schematic structural diagram of a communication device provided by an embodiment of the present disclosure.

FIG. 10 is a schematic structural diagram of a chip provided by an embodiment of the present disclosure.

FIG. 11 is a schematic block diagram of a communication system provided by an embodiment of the present disclosure.

### DETAILED DESCRIPTION

The technical solution of the embodiments of the present disclosure will be described below in conjunction with the drawings in the embodiments of the present disclosure, and it will be apparent that the described embodiments are part of the embodiments of the present disclosure, but not all of them. Based on the embodiments in the present disclosure, all other embodiments obtained by those of ordinary skill in the art without creative work shall fall within the scope of protection of the present disclosure.

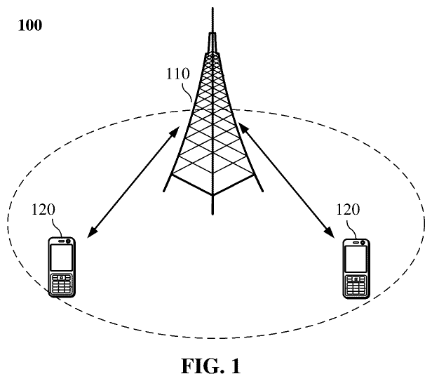

FIG. 1 is a schematic diagram of an architecture of a communication system provided by an embodiment of the present disclosure. As is illustrated in FIG. 1, the communication system 100 may include a network device 110, which may be a device that communicates with a terminal device(s) 120 (or referred to as a communication terminal or a terminal). The network device 110 may provide communication coverage for a particular geographic area and may communicate with terminal devices located within the coverage area.

FIG. 1 exemplarily illustrates one network device and two terminal devices. In some embodiments of the present disclosure, the communication system 100 may include multiple network devices and other numbers of terminal devices may be included within the coverage of each network device, which is not limited by embodiments of the present disclosure.

The terminal device in FIG. 1 may be any terminal device. For example, the terminal device may refer to an access terminal, User Equipment (UE), a subscriber unit, a subscriber station, a mobile station, a mobile platform, a remote station, a remote terminal, a mobile device, a user terminal, a terminal, a wireless communication device, a user agent, or a user device. The access terminal may be a cellular phone, a cordless phone, a session initiation protocol (SIP) telephone, an Internet of Things (IoT) device, a satellite handheld terminal, a wireless local loop (WLL) station, a personal digital assistant (PDA), a handheld device with wireless communication function, a computing device or other processing device connected to a wireless modem, an in-vehicle device, a wearable device, a terminal device in the 5G network or a terminal device in the future evolved network, etc.

It should be noted that FIG. 1 is only illustrative of the system to which the present disclosure applies, and of course, the method illustrated in the embodiments of the present disclosure can also be applied to other systems. In addition, the terms “system” and “network” of the present disclosure are often used interchangeably herein. In the present disclosure, the term “and/or” is used to describe an association relationship of associated objects, and represents that there may be three relationships. For example, A and/or B may represent the following three situations: i.e., independent existence of A, existence of both A and B and independent existence of B. In addition, the character “/” in the present disclosure generally represents that an “or” relationship is formed between the previous and next associated objects. It should be understood that the reference to “indicate” in embodiments of the present disclosure may be a direct indication, may be an indirect indication, or may indicate an association relationship. For example, A indicates B, which may mean that A directly indicates B, for example, B may be obtained through A. It may also mean that A indirectly indicates B, for example, A indicates C, and B may be obtained by C. It may also indicate that there is an association relationship between A and B. It should be understood that “correspond” in the description of embodiments of the present disclosure may mean that there is a direct correspondence or an indirect correspondence relationship between the two, may also mean that there is an association relationship between the two, may also be a relationship between indication and being indicated, configuration and being configured, etc. It should also be understood that the “predefined” or “predefined rules” referred to in embodiments of the present disclosure may be implemented by pre-storing corresponding codes, tables, or other manners that may be used to indicate relevant information in devices (e.g., including terminal devices and network devices), the specific implementation of which is not limited by the present disclosure. For example, predefined may refer to what is defined in the protocol. It should also be understood that, in embodiments of the present disclosure, the “protocol” may refer to standard protocols in the communication field, such as LTE protocol, NR protocol, and related protocols applied in future communication systems, which are not limited herein.

In order to facilitate understanding of the technical solution of the embodiments of the present disclosure, related technologies of the embodiments of the present disclosure are described as follows. The following related technologies can be arbitrarily combined with the technical solution of the embodiments of the present disclosure as optional solutions, all of which belong to the protection scope of the embodiments of the present disclosure.

In Long Term Evolution (LTE), logical cells have one-to-one correspondence to physical cells. Each logical cell has a global unique identifier (i.e., E-UTRAN Cell Global Identifier, ECGI), and each physical cell corresponds to a Physical Cell Identifier (PCI). LTE cells have a central frequency point and an uplink (UL) bandwidth and a downlink (DL) bandwidth. The terminal device determines whether the current cell is a suitable cell and identifies the cell by measuring a Primary Synchronization Signal (PSS)/Secondary Synchronization Signal (SSS) at a central frequency point and reading a Master Information Block (MIB), and then performs an initial cell access process. After the terminal device enters a connected state, an operating bandwidth of the terminal device is the DL bandwidth and UL bandwidth configured in the system broadcast. In LTE, DL carriers and UL carriers are tightly coupled, that is, the DL carriers and the UL carriers belong to the same cell.

In New Radio (NR), the spectrum exhibits characteristics of high frequency and wide range. Each cell has an initial Bandwidth Part (BWP), and on this initial BWP, there is a Synchronization Signal Block (SSB) including the PSS/SSS, and a Physical Broadcast Channel (PBCH), which are used by the terminal devices to search for and identify the cell, followed by executing the cell access process. In NR, Absolute Radio Frequency Channel Number (ARFCN) and Global Synchronization Channel Number (GSCN) are defined at the same time to reduce latency in cell search and energy consumption. After the terminal device enters the connected state, based on network-side configurations, the terminal device may operate on other spectrum ranges other than the initial BWP, that is, operate on a dedicated bandwidth part (dedicated BWP). Up to four dedicated BWPs may be configured by the network side, and these four dedicated BWPs belong to the same frequency band. In NR, in order to compensate for a limited UL coverage problem caused by high frequency, a supplementary uplink (SUL) carrier is introduced, and thus there is one DL carrier and two UL carriers (i.e. a NUL carrier and a SUL carrier) in a cell. The NUL carrier and the SUL carrier are tightly coupled, and the NUL carrier and the SUL carrier belong to the same cell. Here, the SUL carrier is optional, that is, a cell may have only one DL carrier and one NUL carrier.

In future communication standards (such as 6G), terminal devices may operate at high or even ultra-high frequency, with an even broader spectrum range, which will lead to higher time cost and larger energy consumption during cell search. Therefore, considerations must be given to cell search latency and energy consumption of the terminal devices during cell search. Additionally, the number of connections on the network side is expected to increase significantly in the future, and thus an issue of initial access capacity is also a factor that needs to be taken into account. As such, in the future communication standards (such as 6G), cells are required to have fewer frequency points for cell search and more frequency points for cell access, so as to meet requirements of latency in cell search, energy consumption during cell search, and initial access capacity of cells simultaneously. In view of this, the following technical solution of the embodiments in the present disclosure is proposed.

In order to facilitate understanding of the technical solution of the embodiments of the present disclosure, the technical solution of the present disclosure will be described in detail by specific embodiments below. The above related technologies may be combined with the technical solution of the embodiments of the present disclosure arbitrarily as optional solutions, all of which belong to the protection scope of the embodiments of the present disclosure. Embodiments of the present disclosure include at least some of the following.

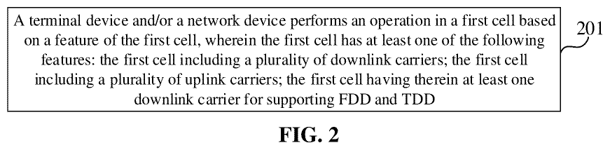

FIG. 2 is a schematic flowchart of a method for multi-carrier based communication provided by an embodiment of the present disclosure. As illustrated in FIG. 2, the method for multi-carrier based communication includes the following actions.

At block 201, a terminal device and/or a network device performs an operation in a first cell based on a feature of the first cell, where the first cell has at least one of the following features: the first cell including a plurality of downlink carriers; the first cell including a plurality of uplink carriers; the first cell including at least one downlink carrier that supports FDD and TDD.

### First Solution

In some embodiments, the first cell includes the plurality of downlink carriers, the network device transmits a first set of signals on a first set of carriers in the plurality of downlink carriers, and the terminal device performs cell search on the first set of carriers in the plurality of downlink carriers to receive the first set of signals; and/or the network device transmits a second set of signals on a second set of carriers in the plurality of downlink carriers, and the terminal device performs initial access on the second set of carriers in the plurality of downlink carriers to receive the second set of signals.

Here, the first cell supports the plurality of downlink carriers, where the first set of carriers is used for cell search, and the second set of carriers is used for initial access, thereby realizing decoupling of cell search and initial access.

In some implementations, the number of the first set of carriers is less than or equal to the number of the second set of carriers. That is, the first cell has fewer frequency points for cell search and more frequency points for cell access, so that the requirements of latency in cell search, energy consumption during cell search and initial access capacity of the cell can be met at the same time. Here, the frequency point refers to the frequency point of a carrier. Since the first set of carriers is used for cell search, frequency points of the first set of carriers belong to frequency points for the cell search. Similarly, since the second set of carriers is used for initial access, frequency points of the second set of carriers belong to frequency points for the cell access.

As an example, the first set of carriers includes T1 downlink carriers, and the second set of carriers includes T2 downlink carriers, where T1 is less than or equal to T2, and T1and T2 are positive integers.

For the terminal device, although the first cell includes the plurality of downlink carriers, the terminal device only needs to perform cell search on the first set of the carriers (such as T1 downlink carriers) to receive the first set of the signals when performing cell search, which can reduce the number of frequency points for cell search and shorten the time for cell search.

In some implementations, after the terminal device performs cell search on the first set of carriers and successfully camps on a target downlink carrier in the first set of carriers, the terminal device receives a system broadcast message on the target downlink carrier, and determines, based on the system broadcast message, carrier information of the plurality of downlink carriers and/or the plurality of uplink carriers included in the first cell. Here, optionally, the carrier information includes at least one of: a carrier identifier, an initial access bandwidth of a carrier, a frequency point of the carrier, or a subcarrier spacing (SCS) of the carrier.

As an example, after the terminal device performs cell search and successfully camps on a downlink carrier (i.e., a frequency point), the terminal device may receive a system broadcast message through the downlink carrier, determine, through the system broadcast message, that a plurality of downlink carriers and/or a plurality of uplink carriers are included in the first cell. Optionally, the terminal device may also determine an initial access bandwidth, a frequency point, an SCS, etc. of each carrier.

For the terminal device, although the first cell includes a plurality of downlink carriers, the terminal device only needs to perform initial access on the second set of the carriers (such as T2 downlink carriers) to receive the second set of the signals when performing initial access. However, the network device may transmit the second set of the signal on a larger number of downlink carriers (e.g., on all downlink carriers of the first cell) to meet the requirements of the initial access capacity of the cell.

In some implementations, the first set of signals includes a synchronization signal block (SSB) or includes both the SSB and a system broadcast message, and the second set of signals includes a paging message and/or a system broadcast message.

In some implementations, the system broadcast message is transmitted on N downlink carriers, and the paging message is transmitted on M downlink carriers, N and M being positive integers.

In some implementations, the paging message and the system broadcast message are transmitted on the same downlink carrier; or the paging message and the system broadcast message are transmitted on different downlink carriers.

In some implementations, in a case that the paging message and the system broadcast message are transmitted on the different downlink carriers, the terminal device receives the paging message and the system broadcast message on different downlink carriers via a plurality of radio frequency components; or the terminal device receives the paging message and the system broadcast message on different downlink carriers in different time periods via a single radio frequency component.

In the above solution, the terminal device and/or the network device may determine a carrier identifier of a downlink carrier of the second set of signals by, but is not limited to, the following manners.
Manner 1: The terminal device determines, based on a first rule, a carrier identifier of a downlink carrier for reception of the second set of signals, and the network device determines, based on the first rule, a carrier identifier of a downlink carrier for transmission of the second set of signals.

In some implementations, the first rule is: UE id mod K=carrier identifier, where UE id is an identifier of the terminal device, and K is the number of the plurality of downlink carriers.
Manner 2: The network device transmits second indication information to the terminal device, the terminal device determines a carrier identifier of a downlink carrier for reception of the second set of signals based on the second indication information from the network device, and the network device determines the carrier identifier of the downlink carrier for transmission of the second set of signals based on the second indication information. The second indication information is used to indicate a carrier identifier of a downlink carrier.

In some implementations, the plurality of downlink carriers belong to the same frequency band; or the plurality of downlink carriers belong to a plurality of frequency bands.

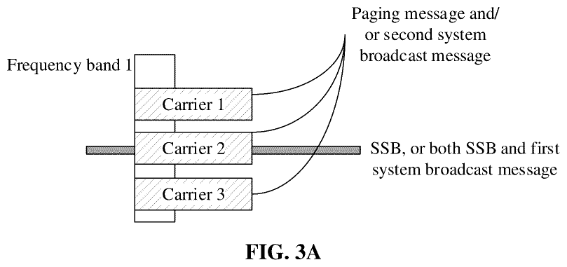

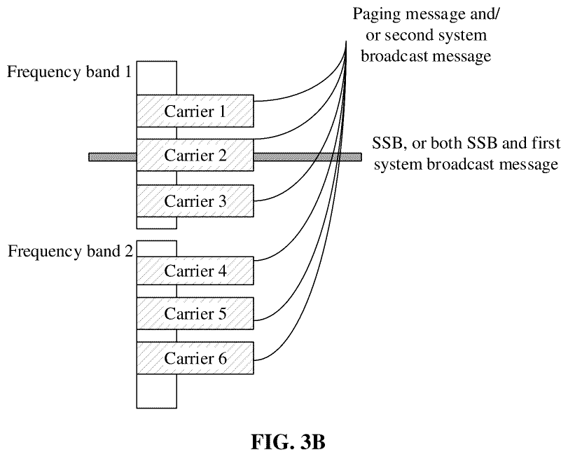

In an example, as illustrated in FIG. 3A, the first cell includes three downlink carriers, namely carrier 1, carrier 2, and carrier 3, and all three carriers belong to frequency band 1. When the terminal device performs cell search, it only performs cell search on carrier 2 to receive SSB or both SSB and the first system broadcast message. After the cell search is successful, the terminal device camps on carrier 2, and identifies on carrier 2 that the cell includes carrier 1, carrier 2 and carrier 3 through the system broadcast message. The network device may transmit a paging message and/or a second system broadcast message on all carrier 1, carrier 2 and carrier 3, while the terminal device only needs to receive the paging message and/or the second system broadcast message on one of carrier 1, carrier 2 and carrier 3. The first system broadcast message and the second system broadcast message may be the same or different or partially different, the first system broadcast message includes OSI and/or RMSI, and the second system broadcast message includes OSI and/or RMSI. For example, the network device may transmit the system broadcast message on only one downlink carrier (e.g., carrier 2 visible during cell search) and may transmit the paging message on the plurality of downlink carriers (e.g., carrier 1, carrier 2, and carrier 3), but the terminal device only needs to receive the paging message on a downlink carrier. If the system broadcast message and paging message are transmitted on different carriers, the terminal device needs to have an ability to receive on different downlink carriers simultaneously. That is, the terminal device receives the paging message and system broadcast message simultaneously on different downlink carriers through multiple radio frequency components. Alternatively, the network side ensures that time periods for which the paging message and the system broadcast message are received do not overlap.

In an example, as illustrated in FIG. 3B, the first cell includes six downlink carriers, which are carrier 1, carrier 2, carrier 3, carrier 4, carrier 5 and carrier 6, respectively, and these six carriers belong to frequency band 1 and frequency band 2. When performing cell search, the terminal device only performs cell search on carrier 2 to receive SSB or both SSB and the first system broadcast message. After the cell search is successful, the terminal device camps on carrier 2, and identifies on carrier 2 that the cell includes carrier 1, carrier 2, carrier 3, carrier 4, carrier 5 and carrier 6 through the system broadcast message. The network device may transmit a paging message and/or a second system broadcast message on all carrier 1, carrier 2, carrier 3, carrier 4, carrier 5 and carrier 6, while the terminal device only needs to receive the paging message and/or the second system broadcast message on one of these carriers. The first system broadcast message and the second system broadcast message may be the same or different or partially different, the first system broadcast message includes OSI and/or RMSI, and the second system broadcast message includes OSI and/or RMSI. For example, the network device may transmit the system broadcast message on only one downlink carrier (e.g., carrier 2 visible during cell search) and may transmit the paging message on the plurality of downlink carriers (e.g., carrier 1, carrier 2, carrier 3, carrier 4, carrier 5 and carrier 6), but the terminal device only needs to receive the paging message on a downlink carrier. If the system broadcast message and paging message are transmitted on different carriers, the terminal device needs to have an ability to receive on different downlink carriers simultaneously. That is, the terminal device receives the paging message and system broadcast message simultaneously on different downlink carriers through multiple radio frequency components. Alternatively, the network side ensures that time periods for which the paging message and the system broadcast message are received do not overlap.

In some implementations, the first cell including a plurality of downlink carriers may dynamically select a set of available downlink carriers according to inter cell interference level.

### Second Solution

In some implementations, the first cell includes a plurality of uplink carriers. Configuration information associated with each of the plurality of uplink carriers includes at least one of: an uplink transmission resource, or an uplink transmission parameter.

Here, optionally, the uplink transmission resource includes at least one of: a physical random access channel (PRACH) resource, a physical uplink control channel (PUCCH) resource, or a physical uplink shared channel (PUSCH) resource.

Here, optionally, the uplink transmission parameter includes a maximum allowed uplink transmission power.

In some implementations, each of the plurality of uplink carriers is associated with at least one of: a type of the terminal device, or a capability supported by the terminal device. The terminal device selects an uplink carrier from the plurality of uplink carriers based on the type of the terminal device and/or the capability supported by the terminal device, and performs uplink transmission based on the selected uplink carrier. Here, optionally, the uplink transmission includes at least one of: PRACH transmission, PUCCH transmission, or PUSCH transmission. The capability supported by the terminal device includes a duplex capability.

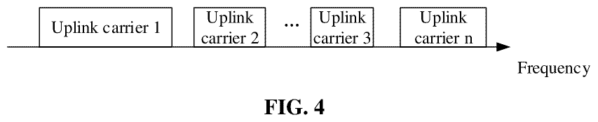

In an example, in future communication systems (such as a 6G system), there is a large number of connections, so a capacity of uplink initial access needs to be increased to meet the demand of accessing of a large number of terminals. Therefore, the cell supports the plurality of uplink carriers, so that the following benefits can be realized: multi-frequency point access to improve uplink coverage; multi-frequency point access to enhance uplink capacity; multi-frequency point handover to improve data transmission performance; and multi-frequency point deployment to enhance cross-cell handover performance. FIG. 4 illustrates a schematic diagram of a cell including n uplink carriers. Each uplink carrier is configured with a PRACH resource, a PUCCH resource, a PUSCH resource, a maximum allowed uplink transmission power (Pmax) required by each carrier, and the like, and these configurations are carried in the system broadcast message. Different uplink carriers may also be used for the following purposes: (1) Different uplink carriers may be used to distinguish different terminal device types. For example, a mapping relationship between uplink carrier indexes and terminal device types is given in the system broadcast message. The terminal devices select, according to their own terminal device types, corresponding uplink carriers to initiate the random access process. The network device identifies the types of accessed terminal devices according to different uplink carriers. (2) Different uplink carriers may be used to distinguish different duplex capabilities. For example, a mapping relationship between uplink carrier indexes and duplex capabilities is given in the system broadcast message. For example, uplink carrier 1 is suitable for terminal devices supporting FDD to access, and uplink carrier 2 is suitable for terminal devices supporting TDD to access, and the like. According to duplex capabilities supported by terminal devices, the terminal devices select corresponding uplink carriers to initiate the random access process. The network device identifies the duplex capabilities of accessed terminal devices according to different uplink carriers.

In some implementations, the plurality of uplink carriers belong to the same frequency band; or the plurality of uplink carriers belong to a plurality of frequency bands.

### Third Solution

In some implementations, the first cell includes at least one downlink carrier supporting FDD and TDD, the terminal device performs cell search on a downlink carrier supporting FDD and TDD, and camps on the downlink carrier supporting FDD and TDD.

In some implementations, the network device transmits, on a downlink carrier supporting FDD and TDD, first indication information to a terminal device camping on the downlink carrier, and the terminal device receives the first indication information sent by the network device. The first indication information is used to indicate an uplink carrier and/or a downlink carrier on which the terminal device operates; and the first indication information is determined by the network device based on a duplex capability of the terminal device.

Here, for an ordinary cell, either TDD or FDD is supported, which depends on the frequency band used by the cell. If a cell only supports FDD, terminal devices that only support TDD cannot access the cell. If a cell only supports TDD, terminal devices that only support FDD cannot access the cell. If a cell supports both FDD and TDD, the cell may be accessed by the terminal devices that only support FDD and the terminal devices that only support TDD simultaneously, which can meet the access requirements of more terminal devices, reduce network construction costs and achieve flexible network establishment. In addition, the terminal devices do not need to blindly detect the types of such cells in the cell search process, which improves the search efficiency.

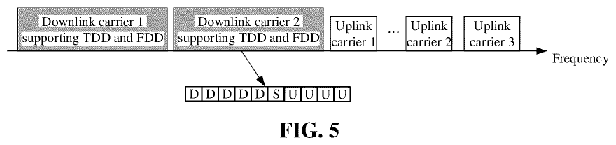

In an example, in future communication systems (such as a 6G system), in the plurality of downlink carriers of a cell, there are one or more downlink carriers that support both FDD and TDD, that is, the downlink carrier(s) is both an FDD carrier and a TDD carrier. As illustrated in FIG. 5, carrier 1 and carrier 2 are downlink carriers that support FDD and TDD. Both the terminal device supporting TDD and the terminal device supporting FDD can identify such carriers and camp on them. After the network device identifies a duplex capability of the terminal device, for example, through an uplink carrier accessed by the terminal device, the network device may determine which uplink carrier and which downlink carrier the terminal device is to operate on.

### Fourth Solution

In some implementations, for the first cell including a plurality of downlink carriers, in order to increase paging capacity, each downlink carrier may be used to transmit a paging message, but it is not necessary to transmit a paging message on each downlink carrier. The terminal device and the network device need to specify a downlink carrier where the paging message is transmitted and the paging message is received, and determination of the downlink carrier may be realized by, but is not limited to, the following manners.
Option 1-1): The carrier identifier of the downlink carrier is determined based on the first rule. For example, the first rule is: UE id mod K=carrier identifier, where UE id is an identifier of a terminal device, and K is the number of the plurality of downlink carriers included in the first cell.
Option 1-2): The carrier identifier of the downlink carrier is determined based on an indication of the network device. For example, the network device sends second indication information to the terminal device, and the second indication information is used to indicate a carrier identifier of a downlink carrier.

In some implementations, for the first cell including a plurality of downlink carriers and a plurality of uplink carriers, in the random access process, the terminal device and the network device need to specify an association relationship between the downlink carriers and the uplink carriers, and the terminal device performs uplink transmission on a first uplink carrier in the plurality of uplink carriers, and receives downlink transmission on a first downlink carrier in the plurality of downlink carriers. The network device receives an uplink transmission on a first uplink carrier in the plurality of uplink carriers and performs downlink transmission on a first downlink carrier in the plurality of downlink carriers. The uplink transmission has an association relationship with the downlink transmission, and the first uplink carrier has an association relationship with the first downlink carrier, and the determination of such association relationship may be realized by, but is not limited to, the following manners.
Option 2-1) The terminal device and/or the network device determine a carrier identifier of the first downlink carrier based on a second rule. The second rule is: information identifier mod K=carrier identifier, where the information identifier is an identifier of uplink information carried in the uplink transmission, and K is the number of the plurality of downlink carriers.

For example, the second rule is: preamble id mod K=carrier identifier. Here, the preamble id is a preamble id selected by the terminal device during the random access process. Here, the preamble is required to be unique within the cell.
Option 2-2) The terminal device and/or the network device determine a carrier identifier of the first downlink carrier based on a identifier of the first uplink carrier.

For example, the identifier of the first uplink carrier is equal to the carrier identifier of the first downlink carrier.
Option 2-3) The network device sends first configuration information to the terminal device, and the terminal device determines a carrier identifier of the first downlink carrier based on the first configuration information from the network device. The first configuration information is used to configure a carrier identifier of a corresponding downlink carrier according to an uplink carrier, or uplink information, or an uplink transmission resource, or an uplink transmission resource group.

For example, the network device configures a carrier identifier of a first downlink carrier through a system broadcast message, and the carrier identifier of the first downlink carrier may be configured per uplink carrier, per preamble, per Random Access Occasion (RO) resource, or per RO resource group.
Option 2-4) The terminal device determines a carrier identifier of the first downlink carrier based on first configuration information from the network device, where the first configuration information is used to configure a carrier identifier of a corresponding downlink carrier according to an uplink carrier, or uplink information, or an uplink transmission resource, or an uplink transmission resource group. Here, the uplink transmission resource group is divided based on frequency domain positions and/or time domain positions of uplink transmission resources.

In the above solution, the uplink transmission is PRACH transmission, and the downlink transmission is random access response (RAR) transmission; or the uplink transmission is message A (MsgA) transmission, and the downlink transmission is message B (MsgB) transmission; or the uplink transmission is PUSCH transmission, and the downlink transmission is physical downlink shared channel (PDSCH) transmission; or the downlink transmission is PDSCH transmission, and the uplink transmission is PUCCH transmission.

### Fifth Solution

In some implementations, the first cell includes a plurality of downlink carriers, the terminal device receives a handover command sent by a network device, where the handover command is used to trigger the terminal device to perform cell handover, and the handover command is a Layer 1 command or a Layer 2 command. The terminal device performs handover from an operating carrier to a second downlink carrier in the first cell, where the second downlink carrier in the first cell overlaps at least partially with a third downlink carrier in a second cell; and the terminal device performs handover from the second downlink carrier in the first cell to the third downlink carrier in the second cell.

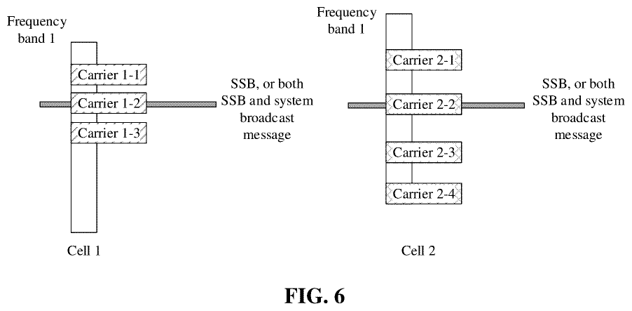

In an example, in a network deployment, for a cell including a plurality of downlink carriers, there may be overlap between neighboring cells on the downlink carriers, as illustrated in FIG. 6. In a cross-cell handover process of a terminal device, the original cell (cell 1) first performs handover from an operating carrier of the terminal device to carrier 1-2 of this cell, which is a carrier overlapping with carrier 2-2 of the neighboring cell, and then performs handover, so that intra-frequency handover may be realized, thereby reducing the impact of handover and improving mobility performance. In addition, handover may be performed based on layer 1 or layer 2 commands during the handover process, thereby realizing fast handover and reducing the impact of handover on data transmission.

Preferred implementations of the present disclosure have been described in detail with reference to the accompanying drawings, but the present disclosure is not limited to the specific details of the above implementations. Within the scope of the technical conception of the present disclosure, various simple modifications may be made to the technical solution of the present disclosure, and these simple modifications all belong to the scope of protection of the present disclosure. For example, each of the specific technical features described in the above specific implementations may be combined in any suitable manner without contradiction, and various possible combinations are not further described in the present disclosure in order to avoid unnecessary repetition. For another example, any combination may be made between the various implementations of the present disclosure so long as it does not depart from the idea of the present disclosure and is likewise to be regarded as the disclosure of the present disclosure. For another example, on the premise of no conflict, various embodiments described in the present disclosure and/or the technical features in various embodiments can be arbitrarily combined with the related art, and the technical solution obtained after combination should also fall within the scope of protection of the present disclosure.

It should be understood that in various method embodiments of the present disclosure, the size of the sequence numbers of the above-mentioned processes does not mean the order of execution, and the execution order of each process should be determined by its function and inherent logic, and should not be limited in any way to the implementation process of the embodiments of the present disclosure. Further, in embodiments of the present disclosure, the terms “downlink”, “uplink” and “sidelink” are used to indicate the transmission direction of signals or data, where “downlink” is used to indicate that the transmission direction of the signals or data is a first direction transmitted from a station to user equipment of the cell, and “uplink” is used to indicate that the transmission direction of the signals or data is a second direction transmitted from the user equipment of the cell to the site, “sidelink” is used to indicate that the transmission direction of the signals or data is a first direction transmitted from user equipment 1 to user equipment 2. For example, “downlink signal” indicates that the transmission direction of the signal is the first direction. In the present disclosure, the term “and/or” is used to describe an association relationship of associated objects, and represents that there may be three relationships. Specifically, A and/or B may represent the following three situations: i.e., independent existence of A, existence of both A and B and independent existence of B. In addition, the character “/” in the present disclosure generally represents that an “or” relationship is formed between the previous and next associated objects.

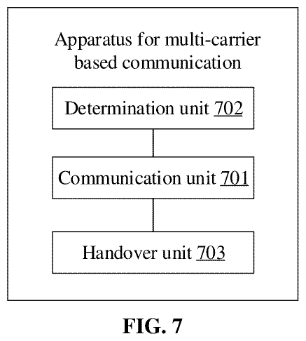

FIG. 7 is a first structural composition diagram of an apparatus for multi-carrier based communication provided by an embodiment of the present disclosure, and the apparatus for multi-carrier based communication is applied to a terminal device. As illustrated in FIG. 7, the apparatus for multi-carrier based communication includes a communication unit 701.

The communication unit 701 is configured to perform an operation in a first cell based on a feature of the first cell, where the first cell has at least one of the following features.

The first cell includes a plurality of downlink carriers.

The first cell includes a plurality of uplink carriers.

The first cell includes at least one downlink carrier supporting frequency division duplexing (FDD) and time division duplexing (TDD).

In some implementations, in a case of the first cell including the plurality of downlink carriers, the action that the terminal device performs the operation in the first cell based on the feature of the first cell includes the following actions.

The terminal device performs cell search on a first set of carriers in the plurality of downlink carriers to receive a first set of signals; and/or
the terminal device performs initial access on a second set of carriers in the plurality of downlink carriers to receive a second set of signals.

In some implementations, the communication unit 701 is configured to: after the terminal device performs cell search on the first set of carriers and successfully camps on a target downlink carrier in the first set of carriers, receive a system broadcast message on the target downlink carrier, and determine, based on the system broadcast message, carrier information of the plurality of downlink carriers and/or the plurality of uplink carriers included in the first cell.

In some implementations, the carrier information includes at least one of: a carrier identifier, an initial access bandwidth of a carrier, a frequency point of the carrier, or a subcarrier spacing (SCS) of the carrier.

In some implementations, the first set of signals includes a synchronization signal block (SSB) or includes both the SSB and a system broadcast message; and the second set of signals includes a paging message and/or a system broadcast message.

In some implementations, the paging message and the system broadcast message are transmitted on the same downlink carrier; or the paging message and the system broadcast message are transmitted on different downlink carriers.

In some implementations, in a case that the paging message and the system broadcast message are transmitted on the different downlink carriers, the terminal device receives the paging message and the system broadcast message on different downlink carriers via a plurality of radio frequency components; or the terminal device receives the paging message and the system broadcast message on different downlink carriers in different time periods via a single radio frequency component.

In some implementations, the system broadcast message is transmitted on N downlink carriers, and the paging message is transmitted on M downlink carriers, N and M being positive integers.

In some implementations, the number of the first set of carriers is less than or equal to the number of the second set of carriers.

In some implementations, the apparatus further includes a determination unit 702, which is configured to determine, based on a first rule, a carrier identifier of a downlink carrier for reception of the second set of signals.

In some implementations, the first rule is: UE id mod K=carrier identifier, where UE id is an identifier of the terminal device, and K is the number of the plurality of downlink carriers.

In some implementations, the apparatus further includes a determination unit 702, which is configured to determine, based on second indication information from a network device, a carrier identifier of a downlink carrier for reception of the second set of signals, where the second indication information is used to indicate a carrier identifier of a downlink carrier.

In some implementations, the plurality of downlink carriers belong to the same frequency band; or the plurality of downlink carriers belong to a plurality of frequency bands.

In some implementations, configuration information associated with each of the plurality of uplink carriers includes at least one of: an uplink transmission resource, or an uplink transmission parameter.

In some implementations, the uplink transmission resource includes at least one of: a physical random access channel (PRACH) resource, a physical uplink control channel (PUCCH) resource, or a physical uplink shared channel (PUSCH) resource.

In some implementations, the uplink transmission parameter includes a maximum allowed uplink transmission power.

In some implementations, each of the plurality of uplink carriers is associated with at least one of: a type of the terminal device, or a capability supported by the terminal device.

In some implementations, the communication unit 701 is configured to select an uplink carrier from the plurality of uplink carriers based on the type of the terminal device and/or the capability supported by the terminal device, and perform uplink transmission based on the selected uplink carrier.

In some implementations, the uplink transmission includes at least one of: PRACH transmission, PUCCH transmission, or PUSCH transmission.

In some implementations, the capability supported by the terminal device includes a duplex capability.

In some implementations, the plurality of uplink carriers belong to the same frequency band; or the plurality of uplink carriers belong to a plurality of frequency bands.

In some implementations, in a case of the first cell including at least one downlink carrier supporting FDD and TDD, the communication unit 701 is configured to perform cell search on a downlink carrier supporting FDD and TDD, and camp on the downlink carrier supporting FDD and TDD.

In some implementations, the communication unit 701 is configured to receive first indication information sent by a network device, where the first indication information is used to indicate an uplink carrier and/or a downlink carrier on which the terminal device operates; and the first indication information is determined by the network device based on a duplex capability of the terminal device.

In some implementations, in a case of the first cell including the plurality of downlink carriers and the plurality of uplink carriers, the communication unit 701 is configured to perform uplink transmission on a first uplink carrier in the plurality of uplink carriers, and receive downlink transmission on a first downlink carrier in the plurality of downlink carriers; where the uplink transmission has an association relationship with the downlink transmission, and the first uplink carrier has an association relationship with the first downlink carrier.

In some implementations, the apparatus further includes a determination unit 702, which is configured to determine a carrier identifier of the first downlink carrier based on a second rule.

In some implementations, the second rule is: information identifier mod K =carrier identifier, where the information identifier is an identifier of uplink information carried in the uplink transmission, and K is the number of the plurality of downlink carriers.

In some implementations, the determination unit 702 is configured to determine a carrier identifier of the first downlink carrier based on an identifier of the first uplink carrier.

In some implementations, the determination unit 702 is configured to determine a carrier identifier of the first downlink carrier based on first configuration information from a network device. The first configuration information is used to configure a carrier identifier of a corresponding downlink carrier according to an uplink carrier, or uplink information, or an uplink transmission resource, or an uplink transmission resource group.

In some implementations, the uplink transmission resource group is divided based on frequency domain positions and/or time domain positions of uplink transmission resources.

In some implementations, the uplink transmission is PRACH transmission, and the downlink transmission is random access response (RAR) transmission; or the uplink transmission is message A (MsgA) transmission, and the downlink transmission is message B (MsgB) transmission; or the uplink transmission is PUSCH transmission, and the downlink transmission is physical downlink shared channel (PDSCH) transmission; or the downlink transmission is PDSCH transmission, and the uplink transmission is PUCCH transmission.

In some implementations, the apparatus further includes a handover unit 703, which is configured to perform handover from an operating carrier to a second downlink carrier in the first cell, where the second downlink carrier in the first cell overlaps at least partially with a third downlink carrier in a second cell; and perform handover from the second downlink carrier in the first cell to the third downlink carrier in the second cell.

In some implementations, the communication unit 701 is configured to receive a handover command sent by a network device, where the handover command is used to trigger the terminal device to perform cell handover, and the handover command is a Layer 1 command or a Layer 2 command.

It will be understood by those skilled in the art that the above description of the apparatus for multi-carrier based communication of the embodiment of the present disclosure may be understood with reference to the description of the method for multi-carrier based communication of the embodiments of the present disclosure.

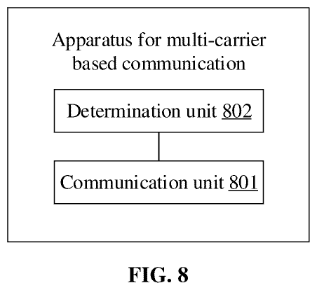

FIG. 8 is a second structural composition diagram of an apparatus for multi-carrier based communication provided by an embodiment of the present disclosure, and the apparatus for multi-carrier based communication is applied to a network device. As illustrated in FIG. 8, the apparatus for multi-carrier based communication includes a communication unit 801.

The communication unit 801 is configured to perform an operation in a first cell based on a feature of the first cell, where the first cell has at least one of the following features.

The first cell includes a plurality of downlink carriers.

The first cell includes a plurality of uplink carriers.

The first cell includes at least one downlink carrier supporting frequency division duplexing (FDD) and time division duplexing (TDD).

In some implementations, the communication unit 801 is configured to transmit a first set of signals on a first set of carriers in the plurality of downlink carriers; and/or transmit a second set of signals on a second set of the plurality of downlink carriers.

In some implementations, the first set of signals includes a synchronization signal block (SSB) or includes both the SSB and a system broadcast message; and the second set of signals includes a paging message and/or a system broadcast message.

In some implementations, the paging message and the system broadcast message are transmitted on the same downlink carrier; or the paging message and the system broadcast message are transmitted on different downlink carriers.

In some implementations, the system broadcast message is transmitted on N downlink carriers, and the paging message is transmitted on M downlink carriers, N and M being positive integers.

In some implementations, the number of the first set of carriers is less than or equal to the number of the second set of carriers.

In some implementations, the apparatus further includes a determination unit 802, which is configured to determine, based on a first rule, a carrier identifier of a downlink carrier for transmission of the second set of signals.

In some implementations, the first rule is: UE id mod K=carrier identifier, where UE id is an identifier of a terminal device, and K is the number of the plurality of downlink carriers.

In some implementations, the communication unit 801 is configured to transmit second indication information to a terminal device, where the second indication information is used to indicate a carrier identifier of a downlink carrier. The determination unit 802 is configured to determine, based on the second indication information, a carrier identifier of a downlink carrier for transmission of the second set of signals.

In some implementations, the plurality of downlink carriers belong to the same frequency band; or the plurality of downlink carriers belong to a plurality of frequency bands.

In some implementations, configuration information associated with each of the plurality of uplink carriers includes at least one of: an uplink transmission resource, or an uplink transmission parameter.

In some implementations, the uplink resource includes at least one of: a physical random access channel (PRACH) resource, a physical uplink control channel (PUCCH) resource, or a physical uplink shared channel (PUSCH) resource.

In some implementations, the uplink transmission parameter includes a maximum allowed uplink transmission power.

In some implementations, each of the plurality of uplink carriers is associated with at least one of: a type of the terminal device, or a capability supported by the terminal device.

In some implementations, the capability supported by the terminal device includes a duplex capability.

In some implementations, the plurality of uplink carriers belong to the same frequency band; or the plurality of uplink carriers belong to a plurality of frequency bands.

In some implementations, in a case that the first cell includes at least one downlink carrier supporting FDD and TDD, the communication unit 801 is configured to transmit, on a downlink carrier supporting both FDD and TDD, first indication information to a terminal device camping on the carrier, where the first indication information is used to indicate an uplink carrier and/or a downlink carrier on which the terminal device operates; and the first indication information is determined by the network device based on a duplex capability of the terminal device.

In some implementations, in a case of the first cell including the plurality of downlink carriers and the plurality of uplink carriers, the communication unit 801 is configured to receive an uplink transmission on a first uplink carrier in the plurality of uplink carriers, and perform downlink transmission on a first downlink carrier in the plurality of downlink carriers; where the uplink transmission has an association relationship with the downlink transmission, and the first uplink carrier has an association relationship with the first downlink carrier.

In some implementations, the apparatus further includes a determination unit 802, which is configured to determine a carrier identifier of the first downlink carrier based on a second rule.

In some implementations, the second rule is: information identifier mod K=carrier identifier, where the information identifier is an identifier of uplink information carried in the uplink transmission, and K is the number of the plurality of downlink carriers.

In some implementations, the determination unit 802 is configured to determine a carrier identifier of the first downlink carrier based on an identifier of the first uplink carrier.

In some implementations, the communication unit 801 is configured to transmit first configuration information to a terminal device, where the first configuration information is used to configure a carrier identifier of a corresponding downlink carrier according to an uplink carrier, or uplink information, or an uplink transmission resource, or an uplink transmission resource group. The determination unit 802 is configured to determine a carrier identifier of the first downlink carrier based on the first configuration information.

In some implementations, the uplink transmission resource group is divided based on frequency domain positions and/or time domain positions of uplink transmission resources.

In some implementations, the uplink transmission is PRACH transmission, and the downlink transmission is random access response (RAR) transmission; or the uplink transmission is message A (MsgA) transmission, and the downlink transmission is message B (MsgB) transmission; or the uplink transmission is PUSCH transmission, and the downlink transmission is physical downlink shared channel (PDSCH) transmission; or the downlink transmission is PDSCH transmission, and the uplink transmission is PUCCH transmission.

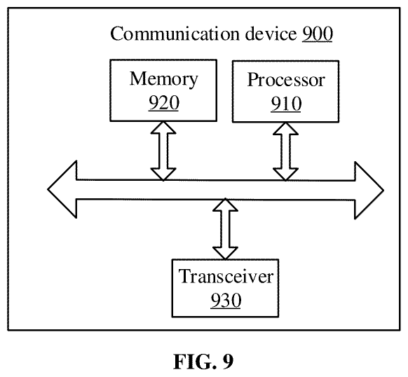

FIG. 9 is a schematic structural diagram of a communication device 900 provided by an embodiment of the present disclosure. The communication device may be a terminal device or a network device. As illustrated in FIG. 9, a communication device 900 includes a processor 910, which may call and execute a computer program from a memory to implement the method in the embodiments of the present disclosure.

Optionally, as illustrated in FIG. 9, the communication device 900 may also include a memory 920. The processor 910 may call and execute a computer program from the memory 920 to implement the method in the embodiments of the present disclosure.

The memory 920 may be a separate device independent of the processor 910 or may be integrated in the processor 910.

Optionally, as illustrated in FIG. 9, the communication device 900 may also include a transceiver 930. The processor 910 may control the transceiver 930 to communicate with other devices, and in particular to send information or data to other devices, or to receive information or data sent by other devices.

The transceiver 930 may include a transmitter and a receiver. The transceiver 930 may further include antennas. The number of antennas may be one or more.

Optionally, the communication device 900 may be specifically a network device of the embodiments of the present disclosure, and the communication device 900 may implement corresponding processes implemented by the network device in various methods of the embodiments of the present disclosure, which will not be repeated here for the sake of brevity.

Optionally, the communication device 900 may be specifically a mobile terminal/terminal device of the embodiments of the present disclosure, and the communication device 900 may implement corresponding processes implemented by the mobile terminal/the terminal device in various methods of the embodiments of the present disclosure, which will not be repeated here for the sake of brevity.

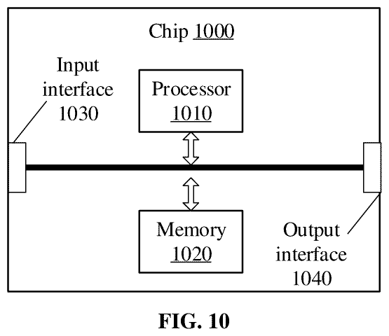

FIG. 10 is a schematic structural diagram of a chip according to an embodiment of the present disclosure. As illustrated in FIG. 10, a chip 1000 includes a processor 1010, which may call and execute a computer program from a memory to implement the method in the embodiments of the present disclosure.

Optionally, as illustrated in FIG. 10, the chip 1000 may also include a memory 1020. The processor 1010 may call and execute a computer program from the memory 1020 to implement the method in the embodiments of the present disclosure.

The memory 1020 may be a separate device independent of the processor 1010 or may be integrated in the processor 1010.

Optionally, the chip 1000 may also include an input interface 1030. The processor 1010 may control the input interface 1030 to communicate with other devices or chips, and in particular to obtain information or data sent by other devices or chips.

Optionally, the chip 1000 may also include an output interface 1040. The processor 1010 may control the output interface 1040 to communicate with other devices or chips, and in particular to output information or data to other devices or chips.

Optionally, the chip may be applied to be a network device of the embodiments of the present disclosure, and the chip may implement corresponding processes implemented by the network device in various methods of the embodiments of the present disclosure, which will not be repeated here for the sake of brevity.

Optionally, the chip may be applied to be a mobile terminal/terminal device of the embodiments of the present disclosure, and the chip may implement corresponding processes implemented by the mobile terminal/the terminal device in the respective methods of the embodiments of the present disclosure, which will not be repeated here for the sake of brevity.

It should be understood that the chip referred to in the embodiments of the present disclosure may also be referred to as a system-level chip, a system chip, a chip system or a system-on-chip or the like.

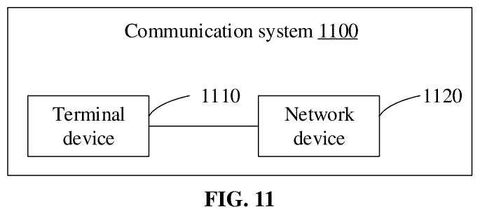

FIG. 11 is a schematic block diagram of a communication system 1100 provided by an embodiment of the present disclosure. As illustrated in FIG. 11, the communication system 1100 includes a terminal device 1110 and a network device 1120.

The terminal device 1110 may be configured to implement corresponding functions implemented by the terminal device in the above method, and the network device 1120 may be configured to implement corresponding functions implemented by the network device in the above method, which will not be repeated here for the sake of brevity.

It should be understood that the processor may be an integrated circuit chip having signal processing capability. In implementation, the actions of the above method embodiments may be accomplished by integrated logic circuitry of hardware in processor or instructions in the form of software. The processor may be a general purpose processor, a digital signal processor (DSP), an application specific integrated circuit (ASIC), a field programmable gate array (FPGA) or other programmable logic devices, discrete gates or transistor logic devices, or discrete hardware components. The processor may implement or execute the methods, actions and logic diagrams disclosed in the embodiments of the present disclosure. The general purpose processor may be a microprocessor or any conventional processor. The actions of the method disclosed in the embodiments of the present disclosure may be directly embodied as being executed by a hardware decoding processor or being executed by the hardware and software modules in a decoding processor. The software modules may be located in a storage medium mature in the art, such as a random access memory, a flash memory, a read-only memory, a programmable read-only memory or an electrically erasable programmable memory, a register, etc. The storage medium is located in the memory, and the processor reads the information in the memory to complete the actions of the aforementioned method in conjunction with its hardware.

It will be appreciated that the memory in the embodiments of the present disclosure may be a volatile memory or a non-volatile memory, or may also include both a volatile memory and a non-volatile memory. The non-volatile memory may be a read-only memory (ROM), a programmable ROM (PROM), an erasable PROM (EPROM), an electrically EPROM (EPROM) or a flash memory. The volatile memory may be a random access memory (RAM), which serves as an external cache. By way of illustration but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), a direct rambus RAM (DR RAM). It should be noted that the memory in the systems and methods described herein is intended to include, but is not limited to, these memories and any other suitable types of memory.

It should be understood that the memory described above is exemplary but not limiting. For example, the memory in the embodiments of the present disclosure may also be a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), a direct rambus RAM (DR RAM), etc. That is, the memory in the embodiments of the present disclosure is intended to include, but is not limited to, these memories and any other suitable types of memory.

In an embodiment of the present disclosure, there is further provided a computer-readable storage medium for storing a computer program.

Optionally, the computer-readable storage medium may be applied to the network device of the embodiments of the present disclosure, and the computer program causes a computer to implement corresponding processes implemented by the network device in the methods of the embodiments of the present disclosure, which will not be repeated here for the sake of brevity.

Optionally, the computer-readable storage medium may be applied to the mobile terminal/terminal device of the embodiments of the present disclosure, and the computer program causes a computer to implement corresponding processes implemented by the mobile terminal/terminal device in the methods of the embodiments of the present disclosure, which will not be repeated here for the sake of brevity.

In an embodiment of the present disclosure, there is further provided a computer program product, which includes computer program instructions.

Optionally, the computer program product may be applied to the network device of the embodiments of the present disclosure, and the computer program instructions cause a computer to implement corresponding processes implemented by the network device in the methods of the embodiments of the present disclosure, which will not be repeated here for the sake of brevity.

Optionally, the computer program product may be applied to the mobile terminal/terminal device of the embodiments of the present disclosure, and the computer program instructions causes a computer to implement corresponding processes implemented by the mobile terminal/terminal device in the methods of the embodiments of the present disclosure, which will not be repeated here for the sake of brevity.

In an embodiment of the present disclosure, there is further provided a computer program.

Optionally, the computer program may be applied to the network device of the embodiments of the present disclosure, and the computer program, when running on a computer, causes the computer to implement corresponding processes implemented by the network device in the methods of the embodiments of the present disclosure, which will not be repeated here for the sake of brevity.

Optionally, the computer program may be applied to the mobile terminal/terminal device of the embodiments of the present disclosure, and the computer program, when running on a computer, causes the computer to implement corresponding processes implemented by the mobile terminal/terminal device in the methods of the embodiments of the present disclosure, which will not be repeated here for the sake of brevity.

Those of ordinary skill in the art may realize that the various example units and algorithm steps described in connection with the embodiments disclosed herein may be implemented in electronic hardware or in a combination of computer software and electronic hardware. Whether these functions are performed in hardware or software depends on the specific application and design constraints of the technical solution. Professionals may use different methods for each particular application to implement the described functionality, but such implementation should not be considered beyond the scope of the present disclosure.

Those skilled in the art will clearly appreciate that, for convenience and conciseness of description, the specific operating processes of the above-described systems, apparatuses and units may refer to the corresponding processes in the aforementioned method embodiments and will not be repeated herein.

In several embodiments provided herein, it should be understood that the disclosed systems, apparatuses and methods may be implemented in other manners. For example, the above-described embodiments of the apparatus are only schematic, for example, the division of the units is only a logical function division, and in practice, there may be another division manner, for example, multiple units or components may be combined or integrated into another system, or some features may be ignored or not performed. On the other hand, the coupling or direct coupling or communication connection between each other illustrated or discussed may be indirect coupling or communication connection through some interfaces, devices or units, and may be electrical, mechanical or other form.

The units illustrated as separate elements may or may not be physically separated, and the elements displayed as units may or may not be physical units, i.e. may be located in a place, or may be distributed over a plurality of network units. Part or all of the units may be selected according to the actual needs to achieve the purpose of the embodiments of the present disclosure.

In addition, each functional unit in each embodiment of the present disclosure may be integrated in one processing unit, each unit may exist physically alone, or two or more units may be integrated in one unit.

When the functions are realized in the form of software functional units and sold or used as an independent product, they may be stored in a computer readable storage medium. Based on such an understanding, the technical solutions according to the disclosure, in essence or the part contributing to the prior art, or part of the technical solutions can be embodied in the form of a software product. The computer software product is stored in a storage medium, and includes several instructions so that a computer device (which may be a personal computer, a server, a network device or the like) implements all or part of the method according to respective embodiments of the disclosure. The aforementioned storage medium includes various media capable of storing a program code such as a USB disk, a mobile hard drive disk, a read-only memory (ROM), a random access memory (RAM), a magnetic disk or an optical disk.

The above is only the specific implementation of the present disclosure, but the scope of protection of the present disclosure is not limited thereto. Any person skilled in the art may easily think of changes or substitutions within the technical scope disclosed in the present disclosure, which should be covered within the protection scope of the present disclosure. Therefore, the scope of protection of the present disclosure shall be subject to the scope of protection of the claims.

1. A method for multi-carrier based communication, comprising:
performing, by a terminal device, an operation in a first cell based on a feature of the first cell, wherein the first cell has at least one of the following features:
the first cell comprising a plurality of downlink carriers;
the first cell comprising a plurality of uplink carriers;
the first cell comprising at least one downlink carrier that supports frequency division duplexing (FDD) and time division duplexing (TDD).

2. The method of claim 1, wherein in a case of the first cell comprising the plurality of downlink carriers, performing, by the terminal device, the operation in the first cell based on the feature of the first cell comprises:
performing, by the terminal device, cell search on a first set of carriers in the plurality of downlink carriers to receive a first set of signals; and/or
performing, by the terminal device, initial access on a second set of carriers in the plurality of downlink carriers to receive a second set of signals.

3. The method of claim 2, further comprising:
after the terminal device performs cell search on the first set of carriers and successfully camps on a target downlink carrier in the first set of carriers, receiving, by the terminal device, a system broadcast message on the target downlink carrier, and determining, by the terminal device based on the system broadcast message, carrier information of the plurality of downlink carriers and/or the plurality of uplink carriers comprised in the first cell,
wherein the carrier information comprises at least one of: a carrier identifier, an initial access bandwidth of a carrier, a frequency point of the carrier, or a subcarrier spacing (SCS) of the carrier.

4. The method of claim 2, wherein
the first set of signals comprises a synchronization signal block (SSB), or comprises both the SSB and a system broadcast message; and the second set of signals comprises a paging message and/or a system broadcast message,
wherein the paging message and the system broadcast message are transmitted on the same downlink carrier; or
the paging message and the system broadcast message are transmitted on different downlink carriers,
wherein in a case that the paging message and the system broadcast message are transmitted on the different downlink carriers,
the terminal device receives the paging message and the system broadcast message on different downlink carriers via a plurality of radio frequency components; or the terminal device receives the paging message and the system broadcast message on the different downlink carriers at different time periods via a single radio frequency component,
wherein the system broadcast message is transmitted on N downlink carriers, and the paging message is transmitted on M downlink carriers, N and M being positive integers.

5. The method of claim 2, wherein a number of the first set of carriers is less than or equal to a number of the second set of carriers.

6. The method of claim 2, further comprising:
determining, by the terminal device based on a first rule, a carrier identifier of a downlink carrier for reception of the second set of signals,
wherein the first rule is: UE id mod K=carrier identifier, wherein UE id is an identifier of the terminal device, and K is a number of the plurality of downlink carriers.

7. The method of claim 2, further comprising:
determining, by the terminal device based on second indication information from a network device, a carrier identifier of a downlink carrier for reception of the second set of signals, wherein the second indication information is used to indicate a carrier identifier of a downlink carrier.

8. A terminal device, comprising: a processor and a memory, wherein the memory is configured to store a computer program, and the processor is configured to call and execute the computer program from the memory to cause the terminal device to:
perform an operation in a first cell based on a feature of the first cell, wherein the first cell has at least one of the following features:
the first cell comprising a plurality of downlink carriers;
the first cell comprising a plurality of uplink carriers;
the first cell comprising at least one downlink carrier that supports frequency division duplexing (FDD) and time division duplexing (TDD).

9. The terminal device of claim 8, wherein the processor is specifically configured to call and execute the computer program from the memory to cause the terminal device to: in a case of the first cell comprising the plurality of downlink carriers,
perform cell search on a first set of carriers in the plurality of downlink carriers to receive a first set of signals; and/or
perform initial access on a second set of carriers in the plurality of downlink carriers to receive a second set of signals.

10. The terminal device of claim 9, wherein a number of the first set of carriers is less than or equal to a number of the second set of carriers.

11. The terminal device of claim 9, wherein the processor is further configured to call and execute the computer program from the memory to cause the terminal device to:
determine, based on a first rule, a carrier identifier of a downlink carrier for reception of the second set of signals,
wherein the first rule is: UE id mod K=carrier identifier, wherein UE id is an identifier of the terminal device, and K is a number of the plurality of downlink carriers.

12. The terminal device of claim 9, wherein the processor is further configured to call and execute the computer program from the memory to cause the terminal device to:
determine, based on second indication information from a network device, a carrier identifier of a downlink carrier for reception of the second set of signals, wherein the second indication information is used to indicate a carrier identifier of a downlink carrier.

13. The terminal device of claim 8, wherein configuration information associated with each of the plurality of uplink carriers comprises at least one of: an uplink transmission resource, or an uplink transmission parameter,
wherein the uplink transmission resource comprises at least one of: a physical random access channel (PRACH) resource, a physical uplink control channel (PUCCH) resource, or a physical uplink shared channel (PUSCH) resource.

14. The terminal device of claim 8, wherein each of the plurality of uplink carriers is associated with at least one of: a type of the terminal device, or a capability supported by the terminal device,
wherein in a case of the first cell comprising the plurality of uplink carriers, performing the operation in the first cell based on the feature of the first cell comprises:
selecting an uplink carrier from the plurality of uplink carriers based on the type of the terminal device and/or the capability supported by the terminal device, and performing uplink transmission based on the selected uplink carrier,
wherein the uplink transmission comprises at least one of: PRACH transmission, PUCCH transmission, or PUSCH transmission,
wherein the capability supported by the terminal device comprises a duplex capability.

15. A network device, comprising: a processor and a memory, wherein the memory is configured to store a computer program, and the processor is configured to call and execute the computer program from the memory to cause the network device to:
perform an operation in a first cell based on a feature of the first cell, wherein the first cell has at least one of the following features:
the first cell comprising a plurality of downlink carriers;
the first cell comprising a plurality of uplink carriers;
the first cell comprising at least one downlink carrier that supports frequency division duplexing (FDD) and time division duplexing (TDD).

16. The network device of claim 15, wherein the processor is further configured to call and execute the computer program from the memory to cause the network device to:
transmit a first set of signals on a first set of carriers in the plurality of downlink carriers; and/or
transmit a second set of signals on a second set of the plurality of downlink carriers.

17. The network device of claim 16, wherein
the first set of signals comprises a synchronization signal block (SSB), or comprises both the SSB and a system broadcast message, and the second set of signals comprises a paging message and/or a system broadcast message,
wherein the paging message and the system broadcast message are transmitted on the same downlink carrier; or the paging message and the system broadcast message are transmitted on different downlink carriers,
wherein the system broadcast message is transmitted on N downlink carriers, and the paging message is transmitted on M downlink carriers, N and M being positive integers.

18. The network device of claim 16, wherein a number of the first set of carriers is less than or equal to a number of the second set of carriers.

19. The network device of claim 15, wherein the processor is further configured to call and execute the computer program from the memory to cause the network device to:
determine, based on a first rule, a carrier identifier of a downlink carrier for transmission of the second set of signals,
wherein the first rule is: UE id mod K=carrier identifier, wherein UE id is an identifier of a terminal device, and K is a number of the plurality of downlink carriers.

20. The network device of claim 15, wherein the processor is further configured to call and execute the computer program from the memory to cause the network device to:
transmit second indication information to a terminal device, wherein the second indication information is used to indicate a carrier identifier of a downlink carrier; and
determine, based on the second indication information, a carrier identifier of a downlink carrier for transmission of the second set of signals.
